(19) United States
(12) Patent Application Publication
(10) Pub. No.: US 2013/0037709 A1
(43) Pub. Date: Feb. 14, 2013

(54) Method for Clinically Monitoring Niacin and Niacin Metabolites in Serum or Plasma

(71) Applicants: Edward J. Barbieri, Willow Grove, PA (US); Robert A. Middleberg, Willow Grove, PA (US)

(72) Inventors: Edward J. Barbieri, Willow Grove, PA (US); Robert A. Middleberg, Willow Grove, PA (US)

(21) Appl. No.: 13/643,730

(22) PCT Filed: May 1, 2011
(86) PCT No.: PCT/US11/34711

§ 371 Date: Oct. 26, 2012

Related U.S. Application Data
(60) Provisional application No. 61/330,324, filed on May 1, 2010.

(51) Int. Cl. H01J 49/26; G01N 27/62

(52) U.S. Cl. 250/282; 252/408.1

(57) ABSTRACT

The present invention provides methods for determining the amount of nicotinic acid and its active metabolites in a biological sample using mass spectrometry. The methods involve specific sample collection processes necessary to stabilize and facilitate simultaneous analysis of nicotinic acid and active metabolites. Once in the laboratory, sample preparation is followed by solid phase extraction, liquid chromatographic separation of relevant moieties with detection by MS/MS whereby specific ion transitions are monitored. This invention has several clinical utilities, particularly those related to monitoring patients on antihyperlipidemic drug therapy.

### BACKGROUND

1. Field of Invention

The present invention relates to analytical methods for identifying, screening, and characterizing niacin and its metabolites. More specifically, the present invention provides a quantitative assay for nicotinic acid, nicotinamide and nicotinuric acid in serum or plasma of individuals using niacin as a vitamin or for the treatment of hyperlipidemia.

2. Description of Related Art

Niacin, also called nicotinic acid, pyridine 3-carboxylic acid, vitamin B3 or vitamin PP, is a water soluble vitamin. The known biological roles of niacin are attributable to the function of its active metabolites, nicotinamide adenine dinucleotide (NAD) and nicotinamide adenine dinucleotide phosphate (NADP).

In humans, niacin equivalents can be obtained from dietary nicotinate, nicotinamide, and tryptophan. Consequently, niacin status depends on the amount of these in the diet and on factors that influence uptake, distribution, efficiency of conversion to tissue NAD and NADP, and excretion or reutilization of the nicotinamide moiety formed by the turnover of NAD and NADP. The term niacin number has been chosen as a convenient way to represent niacin status and is defined as the ratio of the concentration of NAD to the concentration of NADP multiplied by 100 in whole blood. For example, if the relative concentrations of NADP ([NADP]) is 1 and NAD ([NAD]) is 0.72, the niacin number would be 72 (from the formula 100.multidot.[NAD]/[NADP]=72 wherein [NAD] is 0.72 and [NADP] is 1). Expressing the values in this way yields a whole number that is linearly related to intracellular NAD content of red blood cells.

Attempts have been, made to measure niacin status in a subject. Previous attempts have involved the determination of urinary metabolites of nicotinamide (R. A. Jacob et al., J. Nutr. 119, 591 (1989)). In these tests the urinary excretion of niacin or niacin metabolites are measured, to infer the niacin status in a subject. These attempts involve multiple biochemical steps that are labor intensive, and slow and do not measure niacin bioavailability or intracellular niacin active metabolites directly. Thus, current methods for measuring niacin status are not suitable to wide scale screening and the relationship of the nicotinamide metabolites to niacin status is still poorly understood.

As shown in FIG. 1, nicotinic acid and its active metabolites are metabolized through different pathways. Nicotinic acid is not directly metabolized to nicotinamide, rather it undergoes a number of metabolic steps to yield NAD⁺, which in turn can be converted, to nicotinamide. In contrast, nicotinamide can be directly converted to nicotinic acid. Nicotinic acid is metabolized to nicotinic acid mononucleotide (NicMN, nicotinic acid ribonucleotide), NicMN is also the first niacin metabolite to which dietary L-tryptophan is converted. NicMN is converted to nicotinic acid adenine dinucleotide (NicAD, desamido-NAD⁺). NicAD is converted in turn to NAD⁺. NAD⁺ has a number of metabolic opportunities. These include the formation of nicotinamide, NADP⁺, Nicotinamide 5′-mononucleotide (NMN), cyclic ADP-ribose and nicotinic acid dinucleotide phosphate (NAADP), NAD also serves as the substrate for mono- (ADP-ribosyl)ation and poly(ADP-ribosyl)ation reactions. Nicotinamide is converted to nicotinic acid via the enzyme nicotinamidase.

Niacin is currently available in 3 formulations (immediate re ease, extended release, and long acting), which differ significantly with respect to safety and efficacy profiles. Immediate-release niacin is generally taken 3 times a day and is associated with adverse flushing, gastrointestinal symptoms, and elevations in blood glucose levels. Long-acting niacin can be taken once daily and is associated with significantly reduced flushing, but its metabolism increases the risk of hepatotoxic effects. Extended-release niacin, also given once daily, has an absorption rate intermediate between the other formulations and is associated with fewer flushing and gastrointestinal symptoms without increasing hepatotoxic risk.

Niacin status derived from whole blood from humans varies over a wide range (C. S. Fu et al., J. Nutr. 119, 1949 (1989)). From this study the mean niacin number is found to be approximately 175 and from the standard deviation it is predicted that 95% of the population would have values between 127 and 223. In a separate study of a large population of 46- to 64-year-old individuals in Malmo, Sweden a range of 28 to 337 was seen, with a mean of 160. The effect of dietary niacin intake on niacin status was shown in a study of individuals undergoing niacin therapy where the average pretherapy value of 175 was increased to 665 by niacin supplements. Taken together these data illustrate that niacin status varies widely in the human population and can be modulated by niacin supplementation.

The assay of the present invention is useful for determining the optimal amounts of niacin to obtain an optimal level of intracellular niacin metabolites (niacin number). NAD is involved with ADP ribose transfer reactions and these reactions have been implicated in a number of metabolic signaling processes (M. K. Jacobson, et al., in ADP-Ribosylating Toxins and G Proteins: Insights Into Signal Transduction, J. Moss and M. Vaughan, eds., p. 479 American Society for Microbiology, Washington, D.C. 1990; K. C. Williamson and J. Moss, in ADP-Ribosylating Toxins and G Proteins: Insights Into Signal Transduction, J. Moss and M. Vaughan, eds.; p. 493. American Society for Microbiology, Washington, D.C., 1990; M. A. De Matteis et al., Proc. Natl. Acad. Sci. U.S.A. 91, 1114 (1994); H. C. Lee et al., Vitam. Horm., 48, 199 (1994); F. -J. Zhang et al., Bioorg. Med. Chem. Lett. 5,2267 (1995); C. Q. Vu et al., J. Biol. Chem. 271, 4747 (1996)) and in cellular recovery from DNA damage (F. R. Althaus and C. Richter, “ADP-Ribosylation of Proteins: Enzymology and Biological Significance.” Springer-Verlag, Berlin, 1987).

Nicotinamide is a vitamin that plays an important role he synthesis of components necessary for the production of ATP. A more familiar tern for nicotinamide is vitamin B3. Vitamin B3 can be found in various meats, peanuts an r sunflower seeds. Nicotinamide is the biologically active form of niacin.

The human body receives its necessary quantities of nicotinamide from two sources: diet, as described above, and by synthesizing nictonamide in the body itself. The human body is able to convert tryptophan, an amino acid regularly found the body, into niacin. Niacin is then converted to nicotinamide, which the body uses for various purposes.

Nicotinamide is sometimes preferred as a supplement because it lacks some of the effects of niacin. Niacin, but not nicotinamide, has been used as a drug to lower blood cholesterol levels. Nicotinamide, on the other hand, has been found to be effective in arthritis and early-onset Type I diabetes.

### Oxidation-Reduction (Redox) Reactions:

Living organisms derive most of their energy from oxidation-reduction reactions, which are processes involving the transfer of electrons. As many as 200 enzymes require the niacin coenzymes, NAD and NADP, mainly to accept or donate electrons for these reactions. NAD functions most often in reactions involving the catabolism of carbohydrates, fats, proteins and alcohol to produce energy while NADP functions more often in the anabolic reactions, such as those used in the synthesis of fatty acids and cholesterol.

### Non-Redox Reactions:

The niacin coenzyme, NAD, is the substrate for two classes of enzymes (mono-ADP-ribosyltransferase and poly-ADP-ribose polymerase) that separate the niacin moiety from NAD and transfer ADP-ribose to proteins.

### Niacin Deficiency

The late stage of severe niacin deficiency is known as pellagra. The most common symptoms of niacin deficiency involve the skin, digestive system, and the nervous system. In the skin, a thick, scaly, darkly pigmented rash develops symmetrically in areas exposed to sunlight. Symptoms related to the digestive system include a bright red tongue, vomiting, and diarrhea. Neurologic symptoms include headache, apathy, fatigue, depression, disorientation, and memory loss. If untreated, pellagra is ultimately fatal.

### The Role in the Treatment of High Cholesterol and Cardiovascular Diseases

Therapy with niacin is unique in that it improves all lipoprotein abnormalities. It significantly reduces low-density lipoprotein cholesterol, triglyceride, and lipoprotein(a) levels, while increasing high-density lipoprotein cholesterol levels. This makes niacin ideal for treating a wide variety of lipid disorders. Niacin-induced changes in serum lipid levels produce significant improvements in both coronary artery disease and clinical outcomes.

Niacin and Nicotinamide are identical in their function as vitamins. However, they differ markedly as pharmacological agents. This is reflected by the fact that niacin is not directly converted to nicotinamide, which arises only from the metabolism of NAD. It is important to note that while both compounds satisfy the vitamin needs, nicotinamide has no antilipidemic activity. Accordingly, there exists a need to assess, at clinically specific and sensitive level niacin, nicotinamide, and other active metaboites in a tissue or fluid sample.

### SUMMARY

The present invention is directed to meeting the needs by providing a simple and convenient method of assaying niacin and its multiple metabolites in a subject. The method incorporates the detection of niacin, nicotinamide and nicotinuric; acid in a biological sample by mass spectrometry, including tandem mass spectrometry. Depending on the metabolite to be detected, the analysis provides information useful to the clinician in the diagnosis and treatment of diseases such as hyperlipidemia. The prior methods are disadvantageous at least because they do not measure niacin and it's metabolites, such as nicotinamide and nicotinuric acid in a consistent and reproducible method, suitable for clinical use. Thus, a need has arisen or a simple and effective way to measure the status of these compounds.

The present invention involves a novel procedure allows quantification of niacin and nicotinamide from serum or plasma using mass spectrometry. The present invention avoids the above noted disadvantages of prior art niacin measurement methods and provides unique advantages over all prior approaches to assessing niacin status in humans. One advantage of the method is that it is capable of measuring niacin and its active metabolites reproducibly.

The methods of the invention may be used in health maintenance, disease prevention, and general patient monitoring.

### BRIEF DESCRIPTION OF THE FIGURES

FIG. 1 is a diagram showing the metabolism of Nicotinic Acid and the active metabolites.

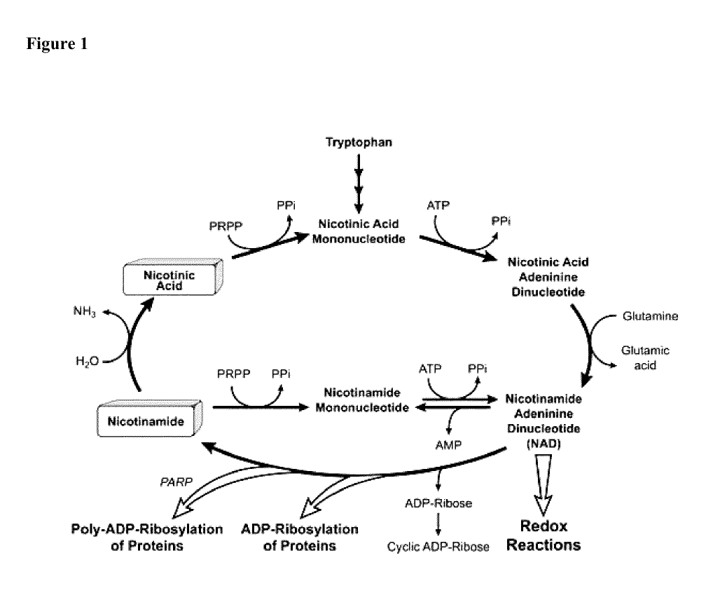

FIG. 2 is a schematic of the steps in LC-MS/MS analysis of nicotinic acrid and the active metabolites.

FIG. 3 is a schematic of the steps the analysis nicotinic acid and the active metabolites.

### DETAILED DESCRIPTION OF INVENTION

The present invention provides methods for quantitating by mass spectrometry the presence or amounts of niacin and its main metabolite niacinamide in plasma or serum Ire one embodiment, methods are provided for a quantitative measurement in a serum or plasma sample, by mass spectrometry, the amount of niacin or niacinamide, that include: (a) extracting niacin and niacinamide in the test sample by sample preparation processes and liquid chromatography; (b) ionizing niacin or niacinamide the test sample; and (c) detecting the amount of niacin or niacinamide via ions(s) produced by mass spectrometry and relating the amount of niacin or niacinamide ion(s) to the amount of niacin or niacinamide in the test sample. Results are reported in “ng/ml” to at least 2 significant figures.

Ina preferred embodiment, methods are provided for determining the amount of niacin or niacinamide in a serum sample by tandem mass spectrometry that include: (a) combining deuterated internal standard with niacin or niacinamide; (b) pH adjusting the biological matrix; (c) extracting niacin or niacinamide a fluid sample by solid-phase extraction; and (d) HPLC separation with electrospray LC-MS/NIS identification and quantitation.

In certain embodiments of the methods disclosed herein, mass spectrometry is performed in positive ion mode. Alternatively, mass spectrometry is performed in negative ion mode. Other embodiments measure niacin or niacinamide using both positive and negative ion mode. In certain embodiments, niacin or niacinamide is measured using either APCI or ESI in either positive or negative mode.

In a preferred embodiment, separately detectable internal standards are added to the sample, the amount of which is also determined in the sample. The internal standards used include deuterated analogs of nicotinic acid, nicotinamide and nicotinuric acid, thus constituting isotope dilution mass spectrometry. In these embodiments, all or a portion of both the endogenous nicotinic acid, nicotinamide or nicotinuric acid and the internal standard present in the sample are ionized to produce a plurality of ions detectable in a mass spectrometer, and one or more ions produced from each are detected by mass spectrometry. Internal standards are D4-nicotinic acid, D4-nicotinamide and D4-nicotinuric acid.

In one embodiment, the methods involve the combination of liquid chromatography with mass spectrometry. In a preferred embodiment, the liquid chromatography is HPLC. A preferred embodiment utilized HPLC alone or in combination with one or more purification methods such extras ting, niacin or niacinamide a fluid sample by solid-phase extraction in the sample. in another embodiment, the mass spectrometry is tandem mass spectrometry (MS/MS).

In general, methods are described using mass spectrometry for detecting and quantifying nicotinic acid, nicotinamide and nicotinuric acid in a test sample. Certain aspects of the invention involve isolating the compounds of interest, ionizing the compounds of interest, detecting the ion(s) by mass spectrometry, and relating the presence or amount of the ion(s) and the presence or amount of related niacin metabolites(s) in the sample. Certain embodiments are particularly well suited for application in large clinical laboratories. Methods of detecting and quantifying nicotinic acid, nicotinamide or nicotinuric acid are provided that have enhanced specificity and/or are accomplished in less time and with less sample preparation than required in assays.

### Definitions

An niacin active metabolite refers to niacin, nicotinamide or nicotinuric acid species that, is present in the circulation of an individual or animal, formed through a biosynthetic or metabolic pathway. In certain embodiments the niacin active metabolites are naturally present in a body fluid of a mammal (such as a human).

A biological sample refers to any sample from a biological source and is usually plasma or serum. Any fluid that can be isolated from front the body of an individual is considered a biological sample. For example but not limited to, body fluid may include, blood, plasma, serum, bile, saliva, urine, tears, perspiration, and the like.

Chromatography refers to a process in which a chemical mixture carried by a liquid or gas is separated into components as a result of differential distribution of the chemical entities between a stationary liquid or solid phase and a flowing liquid or gas.

Liquid chromatography (LC) means a process of selectively retarding one or more components of a fluid solution as the fluid uniformly percolates through a column of a finely divided substance, or through capillary passageways. The retardation results from the distribution of the components of the mixture between one or more stationary phases and the bulk fluid, (i.e. mobile phase), relative to the stationary phase and the related chemical processes, thereof. Liquid chromatography includes reverse phase liquid chromatography (RPLC), normal phase chromatography and a host of other chemistries to facilitate a separation process. Certain forms of liquid chromatography are carried out using HPLC.

High performance liquid chromatography (HPLC) refers liquid chromatography in which the degree of separation is increased by forcing the mobile phase under pressure through a stationary phase, typically a densely packed column.

Mass spectrometry (MS) refers to an analytical technique to identify compounds by their mass to charge ratio, MS technology generally includes four components: (1) sample introduction, e.g. HPLC; (2) ionizing the compounds to form charged compounds; (3) separation of the produced ions; and (4) detecting the charged species by monitoring mass to charge ratios. The compound may be ionized and then detected by any suitable means. See U.S. Pat. No. 6,204,500 “Mass Spectrometry From Surfaces”; U.S. Pat. No. 6,107,623 “Methods and Apparatus for Tandem Mass Spectrometry”; U.S. Pat. No. 6,268,144 “DNA diagnostics Based on Mass Spectrometry” U.S. Pat. No. 6,124,137 “Surface-Enhanced Photolabile Attachment and Release for Desorption and Detection of Analytes”, Wright et al “Prostate Cancer and Prostate Diseases 2:264-276 (1999); and Merchan and Weinberger, Electrophoresis 21:1164-1167 (2000), all incorporated by reference.

Ionization refers to the process of generating an analyte on having a net electrical charge equal to one or more electron units. Negative ions are those having a net negative charge of one or more electron units, while positive ions are those having a net positive charge of one or more electron units.

Operating, in negative ion mode refers to those mass spectrometry methods where negative ions are detected. Similarly, operating in positive ion mode refers to those mass spectrometry methods where positive ions are detected.

### Test Samples

Suitable test samples include any test sample that may be obtained from any biological source, such as an animal, a cell culture, an organ culture, etc. In certain embodiments, samples are obtained from a mammalian animal, such as a dog, cat, horse, etc. Exemplary mammalian animals are primates, most preferably humans. Exemplary samples include blood, plasma, serum, hair, muscle, urine, saliva, tear, cerebrospinal fluid, or other tissue samples. Such samples may be obtained, for example, from a patient; is, a living person presenting oneself in a clinical setting for diagnosis, prognosis, or treatment of a disease or condition. The test sample may be obtained from a patient, for example, blood serum. Samples may also be harvested from deceased individuals.

### Sample Preparation for Mass Spectrometry

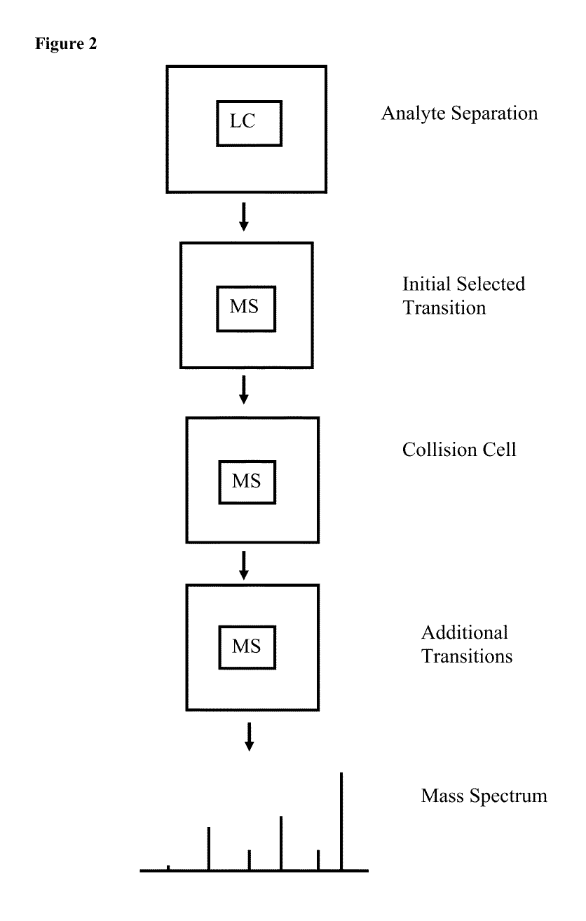

FIG. 2 shows a schematic of the analysis of niacin and its active metabolites. Methods may be used prior to mass spectrometry to enrich niacin and the active metabolites relative to other components in the sample, or to increase the concentration of niacin and the active metabolites in the sample. Such methods include, for example, filtration centrifugation, thin layer chromatography, electrophoresis including capillary electrophoresis, affinity separations including immunoaffinity separations and extraction methods, including solid phase extraction by cation exchange or any combination of the above or the like.

Samples may be processed or purified to obtain preparations that are suitable for analysis by mass spectrometry. Such purification will usually include chromatography, such as liquid chromatography, and may also often involve an additional purification procedure that is performed prior to chromatography. Various procedures may be used for this purpose depending on the type of sample or the type of chromatography. Examples include filtration, extraction, precipitation, centrifugation, delipidization, dilution, combinations thereof and the like

### Liquid Chromatography

Generally, chromatography may be performed prior to mass spectrometry; the chromatography may be liquid chromatography, such as high performance liquid chromatography.

Liquid chromatography including high-performance liquid chromatography rely on relatively slow, laminar flow technology. Traditional HPLC analysis relies on column packing in which laminar flow of the sample and mobile phase through the column is the basis for separation of the analyte of interest from the sample. The skilled artisan will understand that separation such columns is a diffusional process. HPLC has been successfully applied to the separation of compounds in biological samples. But a significant amount of sample preparation is required prior to the separation and subsequent analysis with a mass spectrometer, making this technique labor intensive. In addition, most HPLC systems do not utilize the mass spectrometer fullest potential, allowing only one HPLC system to be connected to a single MS instrument, resulting in lengthy time requirements for performing a large number assays.

The preferred HPLC would include a system that is able to work at much higher pressures, such UPLC systems can work at up to 100 MPa or about 1000 atmospheres.

In certain embodiments, an analyte may be purified by applying a sample to a column under conditions where the analyte of interest is reversibly retained by the column packing material while one or more other materials are not retained. In these embodiments, a first mobile phase condition can be employed where the analyte of interest is retained by the column and a second mobile phase condition can subsequently be employed to remove retained material from the column, once the non-retained materials are washed through. Alternatively, an analyte may be purified by applying a sample to a column under mobile phase conditions where the analyte of interest elutes at a differential rate in comparison to one or more other materials. Such procedures may enrich the amount of one or more analytes of interest relative to one or more other components of the samples.

### Detection and Quantification by Mass Spectrometry

The present invention discloses mass spectrometric methods for detecting the presence or amount of niacin and one or more active metabolites in a sample. In certain aspects, the method involves solid phase extraction of niacin and, the metabolite, ionizing the compounds, detecting the ion(s) by mass spectrometry, and relating the presence or amount of the ion(s) to the presence or amount of niacin and the metabolite in the sample.

Mass spectrometry may be performed using a mass spectrometer which includes an ion source for ionizing the fractionated sample and creating charged molecules for further analysis. For example, ionization of the sample may be performed by electrospray ionization, atmospheric pressure chemical ionization, atmospheric pressure photoionization, photoionization, electron ionization, fast atom bombardment/liquid secondary ionization, matrix assisted laser desorption ionization, field ionization, field desorption, thermospray/plasmaspray ionization, and particle beam ionization. The skilled artisan will understand that the choice of ionization method an be determined based on the analyte to be measure, type of sample, the type of detector choice of positive versus negative mode, etc.

After the sample has been ionized, the positively charged or negatively charged ions thereby created may be analyzed to determine a mass-to-charge ratio (i.e. m/z). Suitable analyzers for determining mass-to-charge ratios include, but are not limited to, quadrupole analyzers, ion trap analyzers, and, time-of-flight analyzers. The ions may be detected using several detection modes. For example, selected ions may be detected (e.g. using a selective ion monitoring mode (SIM), or alternatively, ions may be detected using a scanning mode e.g. multiple reaction monitoring (MRM) or selected reaction monitoring (SRM). The mass-to-charge ratio is determined using a quadrupole, or other, analyzer. For example, in a quadrupole or quadrupole ion trap instrument, ions in an oscillating radio frequency field experience a force proportional to the DC potential applied between electrodes, the amplitude of the RF signal, and m/z. The voltage and amplitude can be selected so that only ions having a particular m/z travel the length of the quadrupole, while all other ions are deflected. Thus, quadrupole instruments can act as both a mass filter and as a mass detector for the ions injected into the instrument.

One may enhance the resolution of the MS technique by employing tandem mass spectrometry or MS/MS. In this technique, a precursor ion (also called a parent ion) generated from a molecule of interest can be filtered in an MS instrument and the precursor ion is subsequently fragmented to yield one fir more fragments ions (also called daughter ions or product ions) that are then analyzed in a second MS procedure. By careful selection of precursor ions, only ions produced by certain analytes are passed to the fragmentation chamber, where collision with atoms of an inert gas produce the daughter ions. Because both the precursor and fragment ions are produced in a reproducible fashion under a given set of ionization/fragmentation conditions, the MS/MS technique can provide an extremely powerful analytical tool. For example, the use of tandem mass spectrometry (MS/MS) can be used to eliminate interfering substances, and can be particularly useful in complex samples, such as biological samples.

The mass spectrometer typically provides the user with an ion scan; that is, the relative abundance of each ion with a particular m/z over a given range (e.g. 100 to 200 amu). The results of an analyte assay, that is, a mass spectrum, can related to the amount of the analyte in the original sample by numerous methods known in the art. For example, standards (a.k.a. calibrators) can be run with the samples, and a standard curve constructed based on ions generated from those standards. Using such a standard curve, the relative abundance of a given ion can be converted into an absolute amount of the molecule present in the sample. In certain embodiments, an internal standard is used as a reference compound to facilitate generation of a standard curve for calculating the quantity of niacin and active metabolites. Methods of generating and using such standard curves are well known in the art and one of ordinary skill is capable of selecting an appropriate internal standard. For example, D4-nicotinic acid as an internal standard for nicotinic acid; D4-nicotinamide as an internal standard for nicotinamide; and D4-nicotinuric acid as an internal standard for nicotinuric acid can be used. Numerous other methods for relating the presence or amount of an ion to the presence or amount of the original molecule will be well known to those of ordinary skill in the art.

In certain embodiments such as MS/MS where precursor ions are isolated for further fragmentation, collision activation dissociation (CAD) is often used to generate the fragment ions for further detection. In CAD, precursor ions gain energy through collisions with an inert gas, and subsequently fragment by processes, including but not limited to, unimolecular decomposition. Sufficient energy must be deposited in the precursor ion so that certain bonds within the ion can be broken due to, but not limited to, increased vibrational energy.

In certain embodiments, nicotinic acid and active metabolites are detected and quantified using LC-MS/MS as follows (see FIG. 2). The samples are subjected to liquid chromatography, preferably UPLC, the flow of liquid solvent from the chromatographic column enters the heated nebulizer interface of a LC-MS/MS analyzer and the solvent/analyte mixture is converted to vapor in the heated tubing of the interface. The analytes contained in the nebulized solvent are ionized through a series of processes involving drying gases, charge application, etc. The pre-selected ions, i.e. precursor ions, pass through the orifice of the instrument and enter the first quadrupole. Quadrupoles 1 and 3 (Q1 and Q3) are mass filters, allowing selection of ions (i.e. precursor and fragment ions) based on the mass to charge ratio (M/Z). Quadrupole 2 (Q2) is the collision cell where precursor ions are fragmented. The first quadrupole of the mass spectrometer (Q1) selects molecules with the mass to charge ratios of the specific niacin and active metabolite moieties to be analyzed. Precursor ions with the correct m/z ratios of the precursor ions of the specific niacin or active metabolite moiety are allowed to pass into the collision chamber (Q2) while unwanted ions with any other m/z collide with the sides of the quadrupole and are eliminated or pumped away. Precursor ions entering Q2 collide with neutral Argon gass molecules and fragment. This process is called Collision Activated Dissociation (CAD). The fragment ions generated are passed into quadrupole 3 (Q3) where the fragment ions of the desired niacin active metabolite moiety are selected while other ions are eliminated.

The methods of the invention may involve MS/MS performed in either positive or negative ion mode. Using standard methods well known in the art, one of ordinary skill is capable of identifying one or more fragment ions of a particular precursor ion of an niacin or active metabolite that can be used for selection in quadrupole 3 (Q3).

In one embodiment, ions collide with the detector and produce a pulse of electrons that are converted to a digital signal. Other detector physics/engineering can be used, e.g., time of flight. The acquired data is relayed to a computer which plots counts of the ions collected versus time. The resulting mass spectra are similar by analogy to chromatograms generated in traditional HPLC methods. The areas under the peaks corresponding to particular ions, or the amplitude of such peaks are measured and the area or amplitude is correlated to the amount of the analyte (niacin or active metabolite moiety) of interest. In certain embodiments, the area under the curves, or amplitude of the peaks, for fragment ion(s) and precursor ions are measured to determine the amount of niacin or active metabolite moiety. As described above, the relative abundance of a given ion can be converted into an absolute amount of the original analyte, i.e. niacin or active metabolite moiety, using calibration standard curves based on peaks of one or more ions of the niacin or active metabolite moiety of interest and an internal standard.

In certain aspects of the invention, the quantity of various ions is determined by measuring the area under the curve or the amplitude of the peak and a ratio of the quantities of the ions is calculated and monitored (i.e. daughter ion ratio monitoring). In certain embodiments of the method, the ratio(s) of a precursor ion and the quantity of one or more fragment ions of an niacin or active metabolite can be calculated and compared to the ratio(s) of a standard of the niacin or active metabolite moiety similarly measured. In embodiments where more than one fragment ion of an niacin or active metabolite is monitored, the ratio(s) for different fragment ions may be determined instead of, or in addition to, the ratio of the fragment ion(s) compared to the precursor ion. In embodiments where such ratios are monitored, if there is a substantial difference in an ion ratio in the sample as compared to the standard, it is likely that a molecule in the sample is interfering with the results or some other analytical phenomenon is in practice. To the contrary, if the ion ratios in the sample and the molecular standard are similar, then there is increased confidence that there is no interference. Accordingly, monitoring such ratios in the samples and comparing the ratios to those of authentic standards may be used to increase the accuracy of the method.

In certain embodiments of the invention, the presence or absence of an amount of two or more niacin or active metabolite moieties in a sample might be detected in a single assay using the above described MS/MS methods.

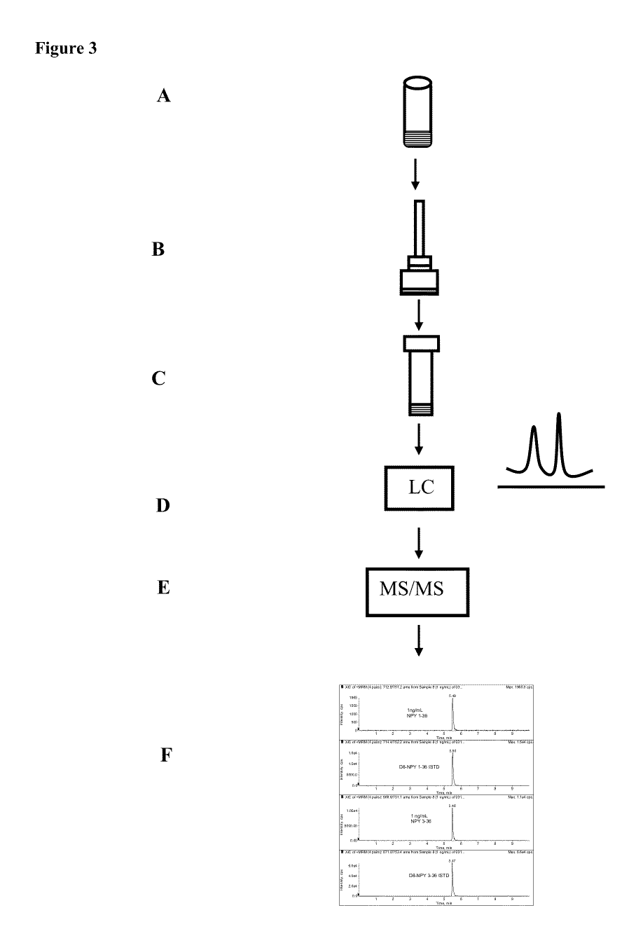

A representation of the steps in niacin and active metabolite processing and analysis is shown schematically in FIG. 3. “A” is a glass collection chamber, preferably a Vacutainer tubes. Using standard clinical laboratory techniques, the serum or plasma is prepared for extraction. “B” represents solid phase extraction by cation exchange using CUBCX123 extraction columns. “C” represents rinsing, drying, and eluting of niacin with a final reconstitution in formic acid. The sample is placed in an autosampler vial and a portion is injected into the LC for UPLC as shown in “D”. In “E”, ions are formed within the first MS, a pre-selected transition (Q1) id forwarded to the collision cell (Q2) whereby additional preselected ion transitions are sorted by Q3. In “F”, the transition tracing are produced and the amount of each metabolite quantitated.

### Selected Methods

One aspect of the invention related to a method for assessing the amount of an niacin or active metabolite moiety in a sample comprising the steps of: (a) isolating the moiety of interest with solid phase extraction (b) injecting, extracted sample into a UPLC (c) mass spectrometric analysis, thereby gen plurality of ions; and detecting and quantifying one or more ions.

In certain embodiments, the present invention relates to any one of the aforementioned methods wherein said sample comprises a biological fluid. In certain embodiments, the present invention relates to any one of the aforementioned method further comprising the step of assaying the amount of niacin or active metabolite in the sample.

In certain embodiments, the present invention relates to any one of the aforementioned methods wherein the niacin or active metabolite moiety is present the first sample at a concentration either at, above or below the limit of quantitation.

In certain embodiments, the present invention relates to any one of the aforementioned methods wherein the niacin or active metabolite moiety is nicotinamide or nicotinuric acid.

In certain embodiments, the present invention relates to any one of the aforementioned methods wherein the mass spectrometer is a Quadrupole, Time-of-Flight (Q-TOF) mass spectrometer, Ion Trap Time-of-Flight (IT-TOF) mass spectrometer, Time-of-Flight (TOF) mass spectrometer or a triple QUAD mass spectrometer (tandem mass spectrometer).

In certain embodiments, the present invention relates to any one of the aforementioned methods wherein the ions are precursor ions and subsequently formed ions.

### Clinical Relevance

Prior to the present invention there has been large variability with respect to “normal” serum/plasma concentrations of niacin and the active metabolites. Consequently, it has not been possible to establish a reference to confidently gauge clinical samples for reporting.

Therefore, an analysis that can simultaneously quantify nicotinic acid, nicotinamide and nicotinuric acid in serum/plasma would be useful. This analysis can be used to establish normal concentrations for these three compounds.

### Stability Data:

Nicotinic acid, nicotinamide and nicotinuric acid are stable in plasma when frozen (at −20±5° C.) for 64 days and after 3 freeze/thaw cycles. When kept at room temperature, nicotinic acid in plasma becomes unstable after 24 hours. Lastly, neither nicotinic acid nor the active metabolites were stable in fresh whole blood.

When used in the present invention, nicotinic acid is stable for 15 days at room temperature and when refrigerated in serum.

For long term storage, glass is the most suitable because of significant changes in the concentration of nicotinamide occurring in polypropylene tubes. Most preferred are Vacutainer tubes containing lithium-heparin as an anticoagulant.

### Selected Kits

The present invention also provides specimen collection kits for conveniently and effectively measuring the amount of nicotinic acid and active metabolites in a biological sample. In certain embodiments, the kit contains specific test tubes containing specific chemicals to stabilize and facilitate nicotinic acid and active metabolite analyses.

A kit of invention may include instructions in any form that are provided in connection with the methods of the invention in such a manner that one of ordinary skill in the art would recognize said instructions and realize they are associated with the methods of the invention.

This invention requires the collection and storage of specimens pre-defined tubes and temperatures. Such directions are associated with t e proper testing of samples for nicotinic acid and active metabolite moieties.

Applicants reserve the right to physically incorporate, o this application any and all materials and information from any such articles, patents, patent applications, or other physical and electronic documents.

Methods illustrated herein may suitably be practiced in the absence of any element or elements, limitation or limitation, not specifically disclosed herein. The terms and expressions used herein have been used as terms of description and not of limitation, and there is no intention in the use of such terms of excluding any equivalents of the features shown and described or portions thereof. It is recognized that various modification are possible within the scope of the invention claimed. Thus, it should be understood that although the present invention has been specifically disclosed by preferred embodiments and other features, modification and variation of the invention embodied therein herein disclosed may be used by those skilled in the art, and that such modification and variations are considered to be within the scope of this invention.

The invention has been described broadly and generically herein. Each of the narrower species and sub-generic grouping falling within the generic disclosure also form part of the methods. This includes the generic description of the methods with a proviso or negative limitation that removing any subject matter from the genus, regardless of whether or not the excised material is specifically recited herein.

1. A method for simultaneously determining nicotinic acid and active metabolite levels in a subject comprising:
a. obtaining a biological fluid sample from a subject;
b. extracting nicotinic acid and active metabolite from said sample;
c. separating nicotinic acid and the active metabolites by liquid chromatrography; and
d. analyzing nicotinic acid and the active metabolites by mass spectrometry wherein said analyzing indicates the level of ions for nicotinic acid and the active metabolites.

2. The method of claim 1 wherein said biological sample is selected from a group consisting of whole blood, serum, and plasma.

3. The method of claim 1 where said biological sample is serum.

4. The method of claim 1 where said biological sample is plasma.

5. The method of claim 1 where said extracting is by solid-phase extraction.

6. The method of claim 5 where said solid-phase extraction uses CUBCX123 extraction columns.

7. The method of claim 1 wherein said liquid chromatography is selected from a group consisting of reverse phase chromatography, normal phase chromatorgraph and HPLC.

8. The method of claim 7 where said HPLC is UPLC.

9. The method of claim 1 wherein said mass spectrometry is tandem mass spectrometry.

10. The method of claim 10 wherein said tandem mass spectrometry includes ionization by electrospray ionization.

11. The method of claim 1 further including the step of correlating said ions with a quantity of nicotinic acid and the active metabolites in said subject.

12. The method of claim 1 wherein the active metabolites are selected from a group consisting of nicotinamide, nicotinuric acid, and combinations thereof.

13. The method of claim 1 wherein the active metabolite is nicotinamide.

14. A method for determining niacin levels in a subject treated for hyperlipidemia comprising:
a. obtaining a sample from a subject;
b. extracting nicotinic acid and active metabolite from said sample;
c. separating nicotinic acid and the active metabolites by liquid chromatography;
d. analyzing nicotinic acid and the active metabolites by mass spectrometry; and
e. correlating the determination of ions for nicotinic acid and the active metabolites is an indication of niacin levels in said subject.

15. The method of claim 15 wherein said sample is from a group consisting of serum, plasma, and combinations thereof.

16. The method of claim 14 wherein said active metabolite is nicotinamide.

17. The method of claim 14 wherein said liquid chromatograph is UPLC.

18. The method of claim 14 wherein said mass spectrometry is tandem mass spectrometry.

19. A kit for determining niacin levels in a test subject comprising:
a. a blood sample from a test subject;
b. CUBCX123 extraction columns;
c. reagents for UPLC separation;
d. reagents for tandem mass spectrometry. And
e. instructions for simultaneous extraction and analysis of nicotinic acid and active metabolites by LC-MS/MS.
